(19) United States
(12) Patent Application Publication
(10) Pub. No.: US 2024/0414361 A1
(43) Pub. Date: Dec. 12, 2024

(54) Transformer Based Neural Network Using Variable Auxiliary Input

(71) Applicant: HUAWEI TECHNOLOGIES CO., LTD., Shenzhen (CN)

(72) Inventors: Georgii Petrovich Gaikov, Munich (DE); Sergey Yurievich Ikonin, Moscow (RU); Ahmet Burakhan Koyuncu, Munich (DE); Alexander Alexandrovich Karabutov, Munich (DE); Timofey Mikhailovich Solovyev, Munich (DE); Elena Alexandrovna Alshina, Munich (DE)

(21) Appl. No.: 18/744,323

(22) Filed: Jun. 14, 2024

Related U.S. Application Data
(63) Continuation of application No. PCT/RU2021/000569, filed on Dec. 15, 2021.

(51) Int. Cl. H04N 19/20; H04N 19/17; H04N 19/82

(52) U.S. Cl. CPC H04N 19/20; H04N 19/17; H04N 19/82

(57) ABSTRACT

A method of processing a current object is provided. A set of input data tensors representing the current object are inputted into a first neural layer of a transformer based neural network. Based on information about processing the current object, at least one auxiliary data tensor is inputted into the first neural layer or a second neural layer of the transformer based neural network, where the at least one auxiliary data tensor is different from each of the input data tensors of the set of input data tensors and represents at least one auxiliary input. The set of input data tensors are processed by the transformer based neural network using the at least one auxiliary data tensor in order to obtain a set of output data tensors.

### CROSS-REFERENCE TO RELATED APPLICATIONS

This application is a continuation of International Application No. PCT/RU2021/000569, filed on Dec. 15, 2021, the disclosure of which is hereby incorporated by reference in its entirety.

### FIELD

The present disclosure generally relates to the field of transformer based neural networks and, particularly, transformer based neural networks making use of variable auxiliary input data in order to obtain improved processing results.

### BACKGROUND

Neural networks (NNs) and deep-learning (DL) techniques making use of artificial neural networks have now been used for some time in a great variety of technical fields including language processing and encoding and decoding of videos, images (e.g. still images) and the like.

Recurrent neural network as well as convolutional neural network architectures are widely used. Recently, transformers have attracted increasing attention both in the field of language processing (for example, text translation) and image processing. Video coding can be facilitated by the employment of neural networks, in particular, transformers.

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. Compression techniques are also suitably applied in the context of still image coding.

With limited network resources and ever increasing demands of higher video quality, improved compression and decompression techniques that improve compression ratio with little to no sacrifice in image quality are desirable.

It is desirable to further improve efficiency of such image coding (video coding or still image coding) based on trained neural networks that account for limitations in available memory and/or processing speed. For this application, as well as for other applications including language processing and processing of acoustic signals it is desirable to further increase the reliability and efficiency of the operation of neural networks, in particular, transformers, used.

### SUMMARY

The present disclosure relates to methods and apparatuses for processing of an object (for example, an image or text) by means of a transformer based neural network that, for example, comprises one or more of the neural networks that are described in the detailed description below.

According to a first aspect, it is provided a method of processing a current object, comprising the steps of:
inputting a set of input data tensors representing the current object into a neural layer of a transformer based neural network;
inputting at least one auxiliary data tensor into a neural layer of the transformer based neural network, wherein the at least one auxiliary data tensor is different from each of the input data tensors of the set of input data tensors and represents at least one auxiliary input; and
processing the set of input data tensors by the transformer based neural network using the at least one auxiliary data tensor in order to obtain a set of output data tensors.

The at least one auxiliary data tensor that is input into the neural layer depends on information about processing the current object (wherein the information is provided by the auxiliary input). For example, in the context of image processing the current object comprises one of an image or a part of an image. The image may be a frame of a video sequence or a still image. For example, in the context of language processing the current object comprises (words of) one or more sentences (spoken or written). For example, in the context of audio processing the object comprises an audio signal.

The transformer based neural network comprises a transformer (see detailed description below) and may, additionally, comprise another neural network, for example, a recurrent or convolutional neural network. The transformer implements the concept of self-attention and comprises at least one self-attention layer (see description below). The result of the processing of the input data tensors (i.e., the model performance) is improved by using information about processing the current object (see also description below). For example, the quality of a decoded image can be enhanced by using this information. The information about processing the current object is not provided by means of a pre-trained and fixed auxiliary input. Rather variable information obtained for the current object is made available for the processing by the transformer based neural network by projecting the auxiliary input to the at least one auxiliary data tensor that provides additional model input. In particular, the information about processing the current object may be information about processing the current object over a continuous or discrete parameter range.

It is noted that existing transformer models (see detailed description below) can relatively easily be adapted to implement the method provided herein. Existing pre-trained models can be used and improved by this method.

Particularly, the current object may be processed during neural network inference or during neural network training. In fact, the method provided herein improves both training and inference results.

According to an implementation, the set of input data tensors is input separately from the at least one auxiliary data tensor. This allows for easily adapting the operation of the transformer based neural network to an arbitrary and arbitrarily changing number of auxiliary inputs which results in a high flexibility of the application of the transformer based neural network. It is noted that the at least one auxiliary data tensor representing the auxiliary input providing the information about processing the current object in tensor space can be processed by the same or similar mathematical operations in the neural layer as the mathematical operations applied to the input data tensors. Particularly, the same weights may be applied to the at least one auxiliary data tensor and the input data tensors in the same neural layer (though different weights may be applied in different neural layers).

When the set of input data tensors is input separately from the at least one auxiliary data tensor, the set of input data tensors may be input into a first neural layer of the transformer based neural network and the at least one auxiliary data tensor may be input into a second neural layer of the transformer based neural network that is different from the first layer. Again. flexibility is increased, since one might select processing on lower level neural layers without usage of auxiliary information/input and processing on selected upper level neural layers with usage of the same, for example.

According to an alternative implementation the set of input data tensors is not input separately from the at least one auxiliary data tensor. In this case, inputting the set of input data tensors and the at least one auxiliary data tensor comprises a) generating a set of different mixed input tensors wherein each mixed input tensor of the set of different mixed input tensors comprises at least one of the at least one auxiliary data tensor and one input data tensor of the set of input data tensors and b) inputting the set of mixed input tensors into the neural layer of the transformer based neural network. In some implementations each of the mixed input tensors of the set of different mixed input tensors comprises at least one of the at least one auxiliary data tensor and exactly one input data tensor of the set of input data tensors.

This implementation allows for individually influencing the processing of each or some of the input data tensors by the at least one auxiliary data tensor. It is noted that the entire set of input data tensors may comprise the mixed input tensors and input tensors that are not mixed (for example, concatenated) with the at least one auxiliary data tensor. Mixing at least one auxiliary data tensor with input data tensors may increase performance in terms of target metrics. Furthermore, some mixture of one or more data tensors output by a particular neural layer of the transformer based neural network with at least one auxiliary data tensor may be performed. Again, the overall architecture allows for a high flexibility of using the auxiliary information and for concrete applications fine-tuning can readily be achieved based on numerical experiments carried out by means of the transformer based neural network.

On a semantic level, according to the above-described methods a current object is processed based on at least one auxiliary input that may represent processing information about continuous or discrete qualities used for processing of the current object. For processing by the transformer based neural network the current object that is to be processed has to be converted into the input data tensors and the at least one auxiliary input has to be converted into the at least one auxiliary data tensor. According to an implementation, the at least one auxiliary data tensor is generated by linearly or non-linearly converting the at least one auxiliary input into the at least one auxiliary data tensor. This can be done by some projection layer receiving the at least one auxiliary input and outputting the at least one auxiliary data tensor that is to be used when processing the input data tensors. Another neural network (for example, a recurrent or convolutional neural network) may be trained and used for optimizing the conversion of the at least one auxiliary input into the at least one auxiliary data tensor.

In principle, the above-described method according to the first aspect and its implementations do not depend on how the information about processing the current object is provided. In the context of coding of the current object, for example, in many applications a bitstream is generated (for example, by an encoder) for the object. Such a bitstream does not only include information on the object itself but also on how to process the object (for example, on a receiver or decoder side). In view of this according to an implementation, the method further comprises obtaining the information about processing the current object from a bitstream generated for the object. Thereby, the information needed can reliably and readily be obtained.

The method according to the first aspect and its implementations can be used for processing of a great variety of objects. For example, in the context of image processing the current object comprises one of an image or a part of an image. The image may be a frame of a video sequence or a still image.

When the current object to be processed comprises an image, the at least one
auxiliary input may be selected from a group comprising
a quality indicating parameter;
channel-wise distortion metrics in signal space;
channel-wise distortion metrics in a latent space;
brightness, contrast, blurring, warmness, sharpness, saturation, color Histogram, cade;
shadowing, luminance, vignette control, painting style;
discontinuously variable filter strength, continuously variable filter strength;
indication of intra prediction or inter prediction; and
conversion rate for object replacement applications.

All of these processing qualities may prove helpful as additional information for increasing the quality of the processed object, particular, in the context of image coding. With respect to image coding, it is provided a method of encoding an image comprising the steps of the method according to the first aspect or any of its implementations and, correspondingly, it is provided a method of decoding an encoded image comprising the steps of the method according to the first aspect or any of its implementations. In the context of video coding, the transformer based neural network may be comprised in an inloop filter. Furthermore, in the context of video coding the transformer based neural network may be suitably used for inter-prediction processing.

Further, it is provided a method of image enhancement comprising the steps of the method according to the first aspect or any of its implementations. Enhancement of the processed image (according to any quality metrics known in the art) may significantly be improved as compared to the art by employing the auxiliary input.

The method according to the first aspect or any of its implementations can also suitably be applied to text or language processing (for example, Natural Language Processing). Thus, according to another implementation, the current object comprises (words of) one or more sentences. In this case, the at least one auxiliary input may be selected from a group comprising temperature (in the context of Natural Language Processing this is a hyper-parameter of neural networks used to control the randomness of predictions by scaling the logits output by a final linear layer before applying softmax; see also description below), language and affection.

The method according to the first aspect or any of its implementations can also suitably be applied to audio signal processing. Thus, according to another implementation, the current object comprises an audio signal. In this case, the at least one auxiliary input may be selected from a group comprising
a quality indicating parameter;
channel-wise distortion metrics in signal space;
channel-wise distortion metrics in any latent space;
equalizer settings;
volume; and
conversion rate.

In the context of audio signal processing, it is provided a method of encoding an acoustic signal comprising the steps of the method according to the first aspect or any of its implementations. Correspondingly, it is provided a method of decoding an encoded acoustic signal comprising the steps of the method according to the first aspect or any of its implementations.

According to a second aspect, it is provided a method of processing a current object by neural network inference. This method according to the second aspect comprises the steps of:
inputting a set of input data tensors representing the current object into a neural layer of a trained transformer based neural network;
inputting at least one auxiliary data tensor into a neural layer of the trained transformer based neural network, wherein the at least one auxiliary data tensor is different from each of the input data tensors of the set of input data tensors and represents at least one auxiliary input; and
processing the set of input data tensors by the trained transformer based neural network using the at least one auxiliary data tensor in order to obtain a set of output data tensors.

The at least one auxiliary data tensor that is input into the neural layer depends on at least one of information about properties of the current object (which is provided by the auxiliary input) and information about processing the current object (which is provided by the auxiliary input).

The result of the processing of the input data tensors (i.e., the model performance) during neural network inference is improved by using information about properties of the current object (for example, content or type/class of content of the current object) and/or information about processing the current object (see description below). This information is not provided by means of a pre-trained and fixed auxiliary input but variable information obtained for the current object is made available for the processing by the transformer based neural network by projecting the auxiliary input to the at least one auxiliary data tensor that provides additional model input. In particular, the information about processing the current object may be information about processing the current object over a continuous or discrete parameter range.

During neural network inference information about properties of the current object, particularly, information about the content of the object, and information about processing the current object can both or alternatively usefully be used in order to improve the result of the processing of the object (for example, the quality of a decoded image can be improved) by means of the transformer based neural network.

While providing the same advantages as described above different implementations of the method according to the second aspect can be realized.

According to an implementation, the set of input data tensors is input separately from the at least one auxiliary data tensor. In this case, the set of input data tensors may be input into a first neural layer of the trained transformer based neural network and the at least one auxiliary data tensor may be input into a second neural layer of the trained transformer based neural network that is different from the first layer. The at least one auxiliary data tensor representing the auxiliary input providing the information about processing the current object in tensor space can be processed by the same or similar mathematical operations in the neural layer as the mathematical operations applied to the input data tensors. Particularly, the same weights may be applied to the at least one auxiliary data tensor and the input data tensors in the same neural layer.

Alternatively, inputting the set of input data tensors and the at least one auxiliary data tensor may comprise a) generating a set of different mixed input tensors wherein each mixed input tensor of the set of different mixed input tensors comprises at least one of the at least one auxiliary data tensor and one input data tensor of the set of input data tensors and b) inputting the set of mixed input tensors into the neural layer of the trained transformer based neural network. In some implementations each of the mixed input tensors of the set of different mixed input tensors comprises at least one of the at least one auxiliary data tensor and exactly one input data tensor of the set of input data tensors.

Similar as described above with reference to the method according to the first aspect provided herein, the method according to the second aspect may further comprise comprising generating the at least one auxiliary data tensor by one of linearly converting the at least one auxiliary input into the at least one auxiliary data tensor, non-linearly converting the at least one auxiliary input into the at least one auxiliary data tensor, and converting the at least one auxiliary input into the at least one auxiliary data tensor by means of another neural network.

According to an implementation of the method according to the second aspect the at least one of information about properties of the current object and the information about processing the current object are information about processing the current object over a continuous or discrete parameter range.

As it was described above, the information about properties of the current object and/or the information about processing the current object can be obtained from a bitstream generated for the object.

The method according to the second aspect, similar to the method according to the first aspect, can also be applied to image processing, language processing (for example, Natural Language Processing) and audio signal processing, for example.

Thus, the current object may comprise one of an image or a part of an image, for example, wherein the image may be a frame of a video sequence or a still image. In this case, the at least one auxiliary input may be selected from a group comprising content, class/type of content;
a quality indicating parameter;
channel-wise distortion metrics in signal space;
channel-wise distortion metrics in a latent space;
brightness, contrast, blurring, warmness, sharpness, saturation, color Histogram, cade;
shadowing, luminance, vignette control, painting style;
discontinuously variable filter strength, continuously variable filter strength;
indication of intra prediction or inter prediction; and
conversion rate for object replacement applications.

Further, it is provided a method of encoding an image or decoding an encoded image comprising the steps of the method according to the second aspect or any of the implementations thereof. Furthermore, it is provided a method of image compression comprising the steps of the method according to the second aspect or any of the implementations thereof.

Other methods addressing particular applications that are provided herein comprise a method of video compression, auto-encoding an image, video coding and image enhancement comprising the steps of the method according to the second aspect or any of the implementations thereof whenever it is considered appropriate. Particularly, the trained transformer based neural network may be comprised in an inloop filter.

According to another implementation of the method according to the second aspect, the current object comprises (words of) one or more sentences. In this case, the at least one auxiliary input is selected from a group comprising content, type of content, temperature (see description above), language and affection.

Alternatively, the current object comprises an audio signal. In the context of audio signal processing the at least one auxiliary input may be selected from a group comprising content, type of content:
a quality indicating parameter;
channel-wise distortion metrics in signal space;
channel-wise distortion metrics in any latent space;
equalizer settings;
volume; and
conversion rate.

In the context of audio signal processing, it is provided a method of encoding an acoustic signal comprising the steps of the method according to the second aspect or any of the above-described embodiments thereof. Correspondingly, it is provided a method of decoding an encoded acoustic signal comprising the steps of the method according to the second aspect or any of the above-described embodiments thereof.

According to a third aspect, it is provided a computer program stored on a non-transitory medium comprising a code which when executed on one or more processors performs the steps of the method according any of the first and second aspects and also the specific implementations of the same described above.

According to a fourth aspect, it is provided a processing apparatus comprising processing circuitry that is configured to perform the steps of the method according to the first aspect or the second aspect described above as well as the above-described implementations.

According to a fifth aspect, a processing apparatus is provided that comprises one or more processors and a non-transitory computer-readable storage medium coupled to the one or more processors and storing programming for execution by the one or more processors, wherein the programming, when executed by the one or more processors, configures the processing apparatus to carry out the method according to the first aspect or the second aspect described above as well as the above-described implementations.

Any of the above-mentioned processing apparatuses may be comprised by a decoding device configured for decoding an encoded image, for example, a still image or frame of a video sequence, or an encoding device configured for encoding an image, for example, still image or a frame of a video sequence. Moreover, it is provided herein an auto-encoding device configured for coding an image and comprising any of the above-mentioned apparatuses.

### BRIEF DESCRIPTION OF THE DRAWINGS

In the following detailed portion of the present disclosure, the aspects, embodiments and implementations will be explained in more detail with reference to the examples shown in the drawings, in which:

FIG. 1 is a schematic drawing illustrating channels processed by layers of a neural network, according to an embodiment of the disclosure;

FIG. 2 is a schematic drawing illustrating an auto-encoder type of a neural network, according to an embodiment of the disclosure;

FIG. 3 is a schematic drawing illustrating network architecture including a hyper-prior model, according to an embodiment of the disclosure;

FIG. 4 is a block diagram illustrating a structure of a cloud-based solution for machine based tasks such as machine vision tasks, according to an embodiment of the disclosure;

FIG. 5 is a block diagram illustrating a structure of end-to-end trainable video compression framework, according to an embodiment of the disclosure;

FIG. 6 is a block diagram illustrating a network for motion vectors compression, according to an embodiment of the disclosure;

FIG. 7 is a block diagram that illustrates a learned image compression configuration of the art, according to an embodiment of the disclosure;

FIG. 8 illustrates a transformer architecture of the art, according to an embodiment of the disclosure;

FIG. 9 illustrates transformer layers of the transformer architecture shown in FIG. 8 in some more detail, according to an embodiment of the disclosure;

FIG. 10 illustrates another transformer architecture of the art employing a class token, according to an embodiment of the disclosure;

FIG. 11 illustrates another transformer architecture of the art employing rotation and contrastive tokens, according to an embodiment of the disclosure;

FIG. 12 illustrates a transformer operating in accordance with an embodiment of the present invention, according to an embodiment of the disclosure;

FIG. 13 illustrates a transformer operating in accordance with another embodiment of the present invention, according to an embodiment of the disclosure;

FIG. 14 illustrates a transformer operating in accordance with another embodiment of the present invention, according to an embodiment of the disclosure;

FIG. 15 is a flow chart illustrating a method of processing an object in accordance with an embodiment of the present invention, according to an embodiment of the disclosure;

FIG. 16 is a flow chart illustrating a method of processing an object in accordance with another embodiment of the present invention, according to an embodiment of the disclosure;

FIG. 17 illustrates a processing apparatus configured for carrying out a method of processing an object in accordance with an embodiment of the present invention, according to an embodiment of the disclosure;

FIG. 18 is a block diagram showing an example of a video coding system configured to implement embodiments of the invention, according to an embodiment of the disclosure;

FIG. 19 is a block diagram showing another example of a video coding system configured to implement embodiments of the invention, according to an embodiment of the disclosure;

FIG. 20 is a block diagram illustrating an example of an encoding apparatus or a decoding apparatus configured to implement embodiments of the invention, according to an embodiment of the disclosure; and

FIG. 21 is a block diagram illustrating another example of an encoding apparatus or a decoding apparatus configured to implement embodiments of the invention, according to an embodiment of the disclosure.

### DESCRIPTION

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps are described. a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

### Convolutional Neural Networks

The name “convolutional neural network” (CNN) indicates that the network employs a mathematical operation called convolution. Convolution is a specialized kind of linear operation. Convolutional networks are simply neural networks that use convolution in place of general matrix multiplication in at least one of their layers.

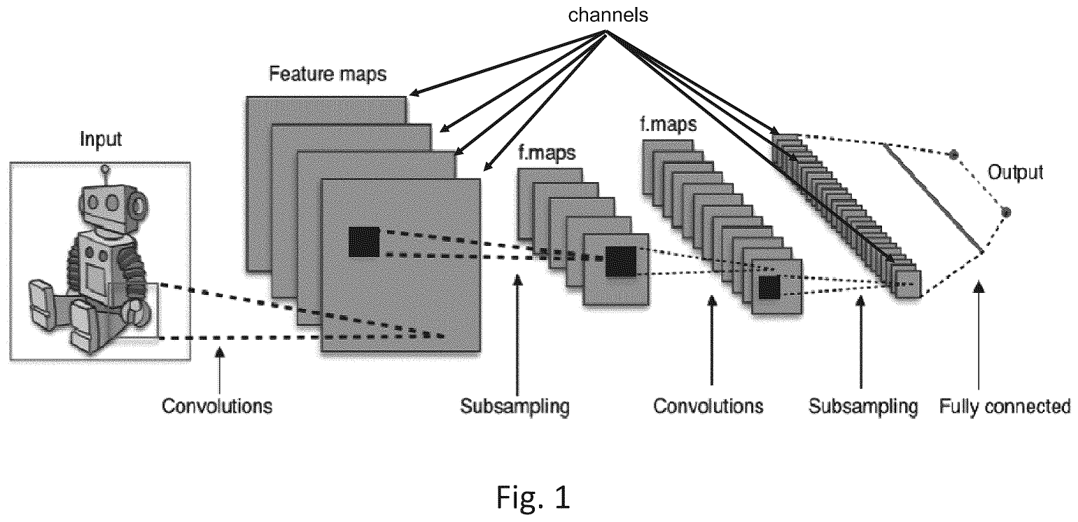

FIG. 1 schematically illustrates a general concept of processing by a neural network such as the CNN. A convolutional neural network consists of an input and an output layer, as well as multiple hidden layers. Input layer is the layer to which the input (such as a portion of an image as shown in FIG. 1) is provided for processing. The hidden layers of a CNN typically consist of a series of convolutional layers that convolve with a multiplication or other dot product. The result of a layer is one or more feature maps (f.maps in FIG. 1), sometimes also referred to as channels. There may be a subsampling involved in some or all of the layers. As a consequence, the feature maps may become smaller, as illustrated in FIG. 1. The activation function in a CNN is usually a RELU (Rectified Linear Unit) layer, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how weight is determined at a specific index point.

When programming a CNN for processing images, as shown in FIG. 1, the input is a tensor with shape (number of images)×(image width)×(image height)×(image depth). Then after passing through a convolutional layer, the image becomes abstracted to a feature map, with shape (number of images)×(feature map width)×(feature map height)×(feature map channels). A convolutional layer within a neural network should have the following attributes: (1) convolutional kernels defined by a width and height (hyper-parameters); (2) the number of input channels and output channels (hyper-parameter); and (3) the depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 down-samples at every depth slice in the input by 2 along both width and height, discarding 75% of the activations. In this case, every max operation is over 4 numbers. The depth dimension remains unchanged.

In addition to max pooling, pooling units can use other functions, such as average pooling or [symbol] 2-norm pooling. Average pooling was often used historically but has recently fallen out of favour compared to max pooling, which performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned RELU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. RELU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in typical convolutional neural network. First, the input image is passed through convolutional layer and becomes abstracted to a feature map comprising several channels, corresponding to number of filters in a set of learnable filters of this layer. Then feature map is subsampled using e.g. pooling layer, which reduces dimension of each channel in feature map. Next data comes to another convolutional layer, which may have different numbers of output channels leading to different number of channels in feature map. As was mentioned above, the number of input channels and output channels are hyper-parameters of the layer. To establish connectivity of the network those parameters needs to be synchronized between two connected layers, such as number of input channels for the current layers should be equal to number of output channels of previous layer. For the first layer which process input data, e.g. image, the number of input channels is normally equal to number of channels of data representation, for instance 3 channels for RGB or YUV representation of images or video, or 1 channel for grayscale image or video representation.

### Autoencoders and Unsupervised Learning

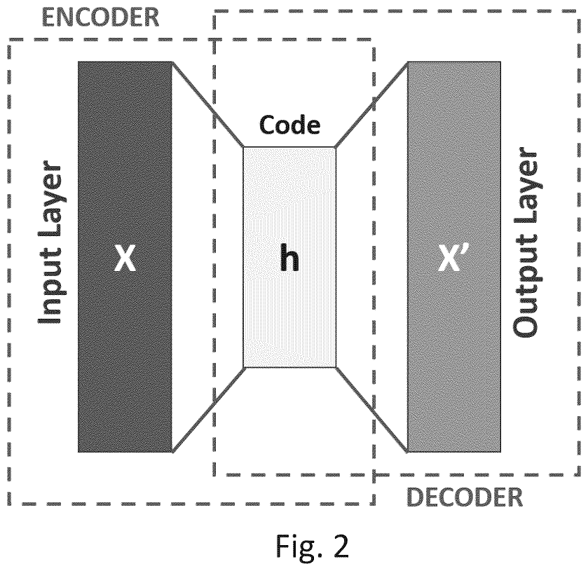

An autoencoder is a type of artificial neural network used to learn efficient data codings in an unsupervised manner. A schematic drawing thereof is shown in FIG. 2. The aim of an autoencoder is to learn a representation (encoding) for a set of data, typically for dimensionality reduction, by training the network to ignore signal “noise”. Along with the reduction side, a reconstructing side is learnt, where the autoencoder tries to generate from the reduced encoding a representation as close as possible to its original input, hence its name. In the simplest case, given one hidden layer, the encoder stage of an autoencoder takes the input x and maps it to h:

$$h = σ ( Wx + b ) .$$

This image h is usually referred to as code, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data are generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{KL} ( {q}_{ϕ} ( h \vert x ) \vert \vert {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, I). Commonly, the shape of the variational and the likelihood distributions are chosen such that they are factorized Gaussians:

$$\begin{matrix}{q}_{ϕ} ( h \vert x ) = ( ρ ( x ) , {ω}^{2} ( x ) I ) \\ {p}_{ϕ} ( x \vert h ) = ( μ ( h ) , {σ}^{2} ( h ) I )\end{matrix}$$

where ρ(x) and ω²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example. End-to-end Optimized Image Compression has been proposed, which uses a network based on variational autoencoder. Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes have finite entropy, continuous-valued data (such as vectors of image pixel intensities) is quantized to a finite set of discrete values, which introduces error. In this context, known as the lossy compression problem, one trades off two competing costs: the entropy of the discretized representation (rate) and the error arising from the quantization (distortion). Different compression applications, such as data storage or transmission over limited-capacity channels, demand different rate-distortion trade-offs. Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation. For example. JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

In J. Balle. L. Valero Laparra, and E. P. Simoncelli (2015). “Density Modeling of Images Using a Generalized Normalization Transformation”. In: arXiv e-prints. Presented at the 4th Int. Conf. for Learning Representations, 2016 (referred to in the following as “Balle”) the authors proposed a framework for end-to-end optimization of an image compression model based on nonlinear transforms. Previously, authors demonstrated that a model consisting of linear-nonlinear block transformations, optimized for a measure of perceptual distortion, exhibited visually superior performance compared to a model optimized for mean squared error (MSE). Here, authors optimize for MSE, but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

For any desired point along the rate-distortion curve, the parameters of both analysis and synthesis transforms are jointly optimized using stochastic gradient descent. To achieve this in the presence of quantization (which produces zero gradients almost everywhere), authors use a proxy loss function based on a continuous relaxation of the probability model, replacing the quantization step with additive uniform noise. The relaxed rate-distortion optimization problem bears some resemblance to those used to fit generative image models, and in particular variational autoencoders, but differs in the constraints authors impose to ensure that it approximates the discrete problem all along the rate-distortion curve. Finally, rather than reporting differential or discrete entropy estimates, authors implement an entropy code and report performance using actual bit rates, thus demonstrating the feasibility of the solution as a complete lossy compression method.

In J. Balle, an end-to-end trainable model for image compression based on variational autoencoders is described. The model incorporates a hyperprior to effectively capture spatial dependencies in the latent representation. This hyperprior relates to side information also transmitted to decoding side, a concept universal to virtually all modern image codecs, but largely unexplored in image compression using ANNs. Unlike existing autoencoder compression methods, this model trains a complex prior jointly with the underlying autoencoder. Authors demonstrate that this model leads to state-of-the-art image compression when measuring visual quality using the popular MS-SSIM index, and yields rate-distortion performance surpassing published ANN-based methods when evaluated using a more traditional metric based on squared error (PSNR).

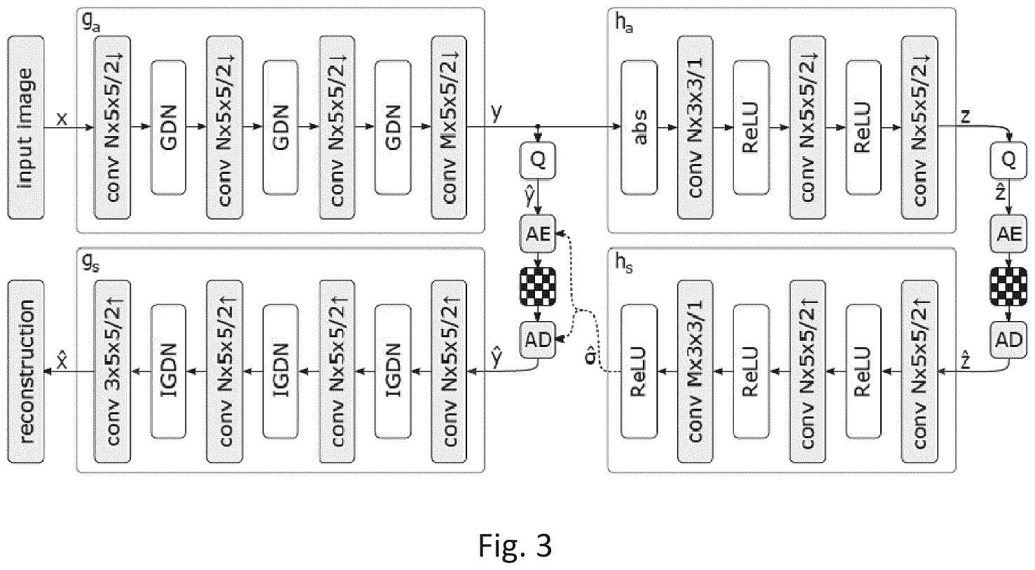

FIG. 3 shows a network architecture including a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

In further works the probability modelling by hyperprior was further improved by introducing autoregressive model e.g. based on PixelCNN++ architecture, which allows to utilize context of already decoded symbols of latent space for better probabilities estimation of further symbols to be decoded, e.g. like it is illustrated on FIG. 2 of L. Zhou. Zh. Sun. X. Wu. J. Wu. End-to-end Optimized Image Compression with Attention Mechanism. CVPR 2019 (referred to in the following as “Zhou”).

### Cloud Solutions for Machine Tasks

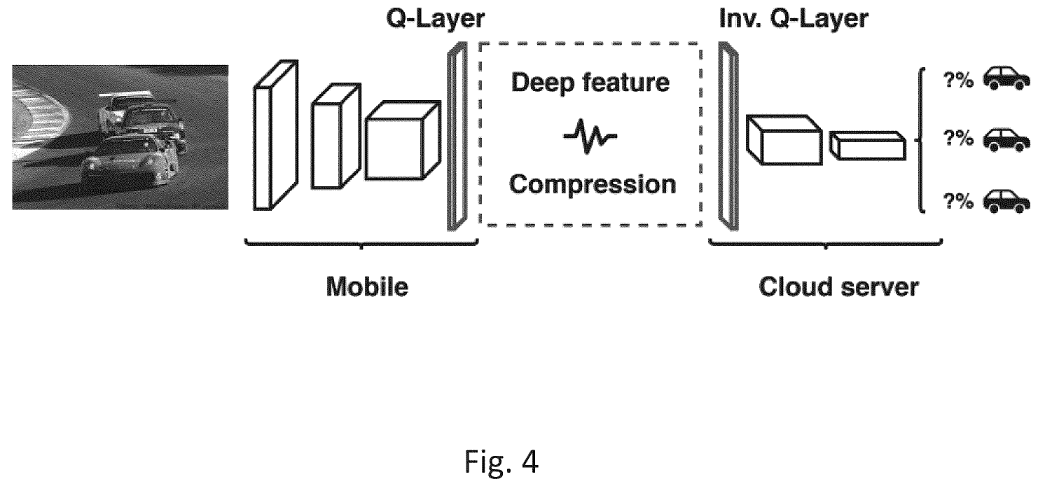

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 4.

Video Coding for Machines is also referred to as collaborative intelligence and it is a relatively new paradigm for efficient deployment of deep neural networks across the mobile-cloud infrastructure. By dividing the network between the mobile and the cloud, it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device and one or more layers may be executed in another device. However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways; from the cloud to the mobile during back-propagation in training, and from the mobile to the cloud during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part to the cloud an output of a hidden layer (a deep feature map), rather than sending compressed natural image data to the cloud and perform the object detection using reconstructed images. The efficient compression of feature maps benefits the image and video compression and reconstruction both for human perception and for machine vision. Entropy coding methods. e.g. arithmetic coding is a popular approach to compression of deep features (i.e. feature maps).

Nowadays, video content contributes to more than 80% internet traffic, and the percentage is expected to increase even further. Therefore, the present disclosure describes building an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile. the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

Recently, deep neural network (DNN) based autoencoder for image compression has achieved comparable or even better performance than the traditional image codecs like JPEG. JPEG2000 or BPG. One possible explanation is that the DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences. A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches in to compress optical flow values will significantly increase the number of bits storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy optimizes the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR). 2019. pp. 11006-11015. authors proposed the end-to-end deep video compression (DVC) model that jointly learns motion estimation, motion compression, and residual coding.

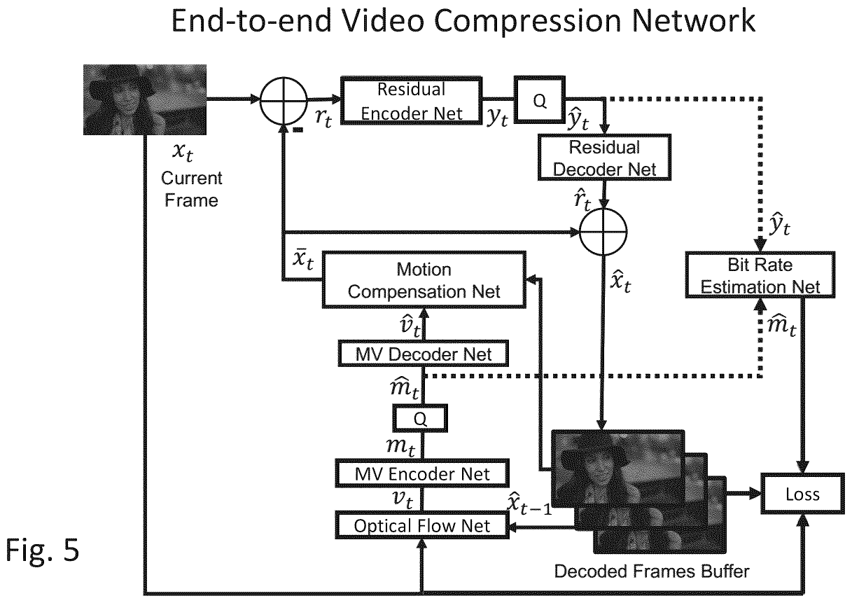

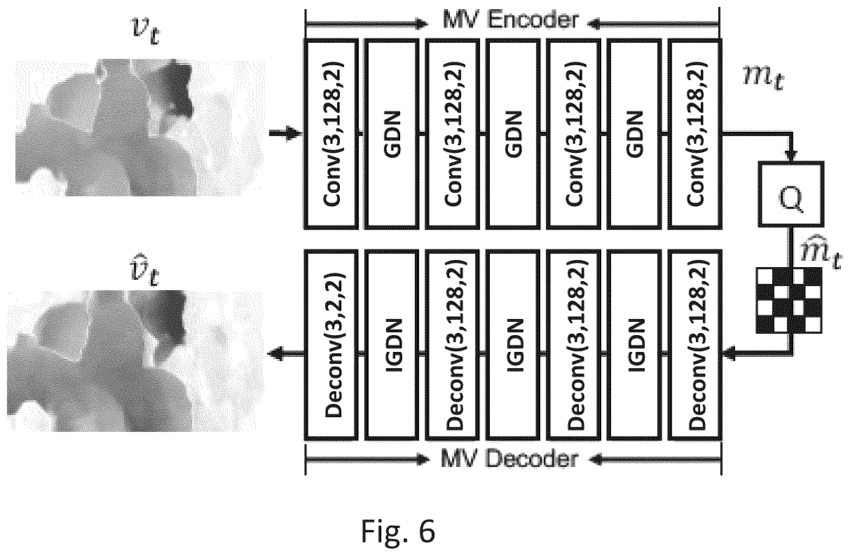

Such encoder is illustrated in FIG. 5. In particular, FIG. 5 shows an overall structure of end-to-end trainable video compression framework. In order to compress motion information, a CNN was designated to transform the optical flow to the corresponding representations suitable for better compression. Specifically, an auto-encoder style network is used to compress the optical flow. The motion vectors (MV) compression network is shown in FIG. 6. The network architecture is somewhat similar to the ga/gs of FIG. 3. In particular, the optical flow is fed into a series of convolution operation and nonlinear transform including GDN and IGDN. The number of output channels for convolution (deconvolution) is 128 except for the last deconvolution layer, which is equal to 2. Given optical flow with the size of M×N×2, the MV encoder will generate the motion representation with the size of M/16×N/16×128. Then motion representation is quantized, entropy coded and sent to bitstream. The MV decoder receives the quantized representation and reconstruct motion information using MV encoder.

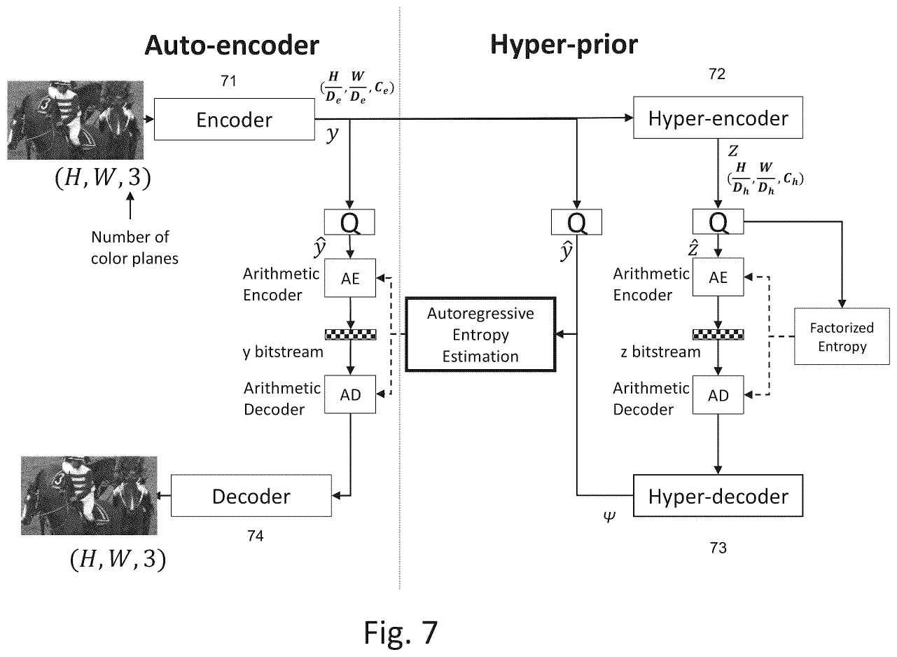

FIG. 7 is a block diagram that illustrates a particular learned image compression configuration comprising an auto-encoder and a hyper-prior component of the art that can be improved according to the present disclosure. The input image to be compressed is represented as a 3D tensor with the size of H×W×C wherein H and W are the height and width (dimensions) of the image, respectively, and C is the number of components (for example, a luma component and two chroma components). The input image is passed through an encoder 71. The encoder down-samples the input image by applying multiple convolutions and non-linear transformations, and produces a latent tensor y. It is noted that in the context of deep learning the terms “down-sampling” and “up-sampling” do not refer to re-sampling in the classical sense but rather are the common terms for changing the size of the H and W dimensions of the tensor. The latent tensor y output by the encoder 71 represents the image in latent space and has the size of

$$\frac{H}{{D}_{e}} \times \frac{W}{{D}_{e}} \times {C}_{e} ,$$

wherein Dₑ is the down-sampling factor of the encoder 71 and Cₑ is the number of channels (for example, the number of neural network layers involved in the transformation of the tensor representing the input image).

The latent tensor y is further down-sampled by a hyper-encoder 72 by means of convolutions and non-linear transforms into a hyper-latent tensor z. The hyper-latent tensor z has the size

$$\frac{H}{{D}_{h}} \times \frac{W}{{D}_{h}} \times {C}_{h}$$

wherein Dₕ is the down-sampling factor of the hyper-encoder 72.

The hyper-latent tensor z is quantized by the block Q in order to obtain a quantized hyper-latent tensor \hat{z}. Statistical properties of the values of the quantized hyper-latent tensor \hat{z} are estimated by means of a factorized entropy model. An arithmetic encoder AE uses these statistical properties to create a bitstream representation of the tensor \hat{z}. All elements of tensor \hat{z} are written into the bitstream without the need of an autoregressive process.

The factorized entropy model works as a codebook whose parameters are available on the decoder side. An arithmetic-decoder AD recovers the hyper-latent tensor \hat{z} from the bitstream by using the factorized entropy model. The recovered hyper-latent tensor \hat{z} is up-sampled by a hyper-decoder 73 by applying multiple convolution operations and non-linear transformations. The up-sampled recovered hyper-latent tensor is denoted by ψ. The entropy of the quantized latent tensor ŷ is estimated autoregressively based on the up-sampled recovered hyper-latent tensor ψ. The thus obtained autoregressive entropy model is used to estimate the statistical properties of the quantized latent tensor ŷ.

An arithmetic encoder AE uses these estimated statistical properties to create a bitstream representation of the quantized latent tensor ŷ. In other words, the arithmetic encoder AE of the auto-encoder component compresses the image information in latent space by entropy encoding based on side information provided by the hyper-prior component. The latent tensor y is recovered from the bitstream by an arithmetic decoder AD on the receiver side by means of the autoregressive entropy model. The recovered latent tensor y is up-sampled by a decoder 74 by applying multiple convolution operations and non-linear transformations in order to obtain a tensor representation of a reconstructed image.

The above-described neural networks can be implemented in the configuration shown in FIG. 7 (for example, for encoding and decoding purposes).

### Transformers

Recently, a new kind of neural networks was introduced that is called “transformer”. Transformers do not comprise recurrent or convolutional neural networks but rely on self-attention. Transformers may also be implemented in the configuration shown in FIGS. 5 and 7, for example. In particular, transformers may be combined with recurrent or convolutional neural networks.

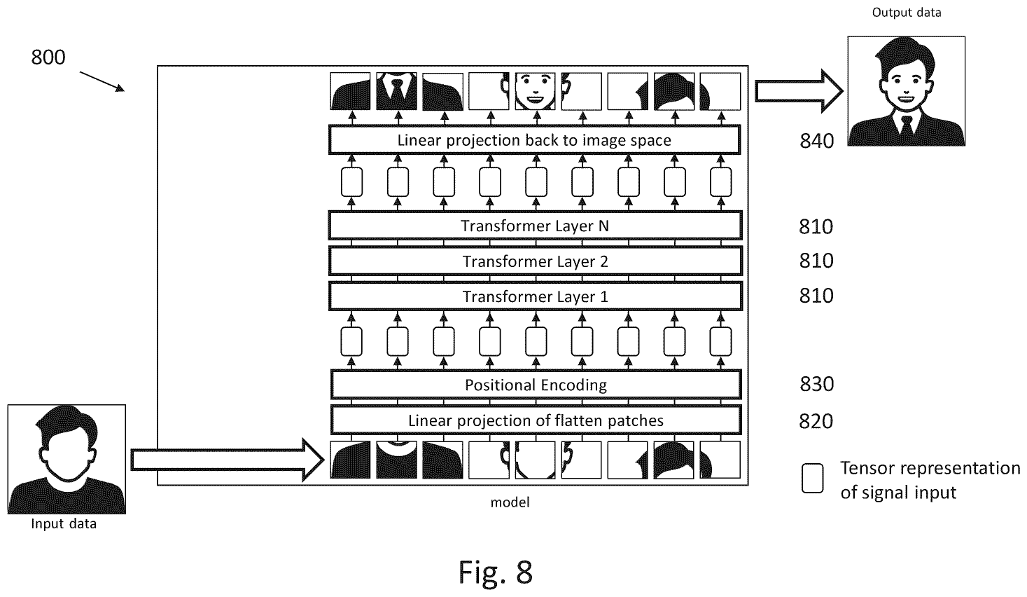

FIG. 8 illustrates an example of a transformer 800 of the art. The transformer 800 comprises neural layers 810 (transformer layers). The transformer 800 may comprise an encoder-decoder architecture comprising encoder neural layers and decoder neural layers. Alternatively, the transformer 800 may comprise an encoder stack of neural layers only. Input data is input into the transformer and output data is output. For example, the transformer 800 is configured for image processing and may output an enhanced image. The input data may comprise patches of an image or words of a sentence, for example. For example, a tokenizer generates tokens in the form of patches from an image or words from a sentence to be processed. These tokens can be converted into (continuous valued) embeddings by some embedding algorithm. According to the example, shown in FIG. 8 a linear projection layer 820 converts the input patches into tensor representations (embeddings) of the portions of the object to be processed (in latent space). These tensor representations of signal input are processed by the transformer 800. Provision of a positional encoding layer 830 provides information on positions of portions of an object to be processed (for example, an image or sentence) relative to each other, for example, positions of patches of an image or words of a sentence relative to each other. A sinusoidal function for the positional encoding may be used.

A final one of the neural layers 810 outputs output data tensors in latent space that are converted back to object space (for example, image or sentence space) by a linear back projection layer 840.

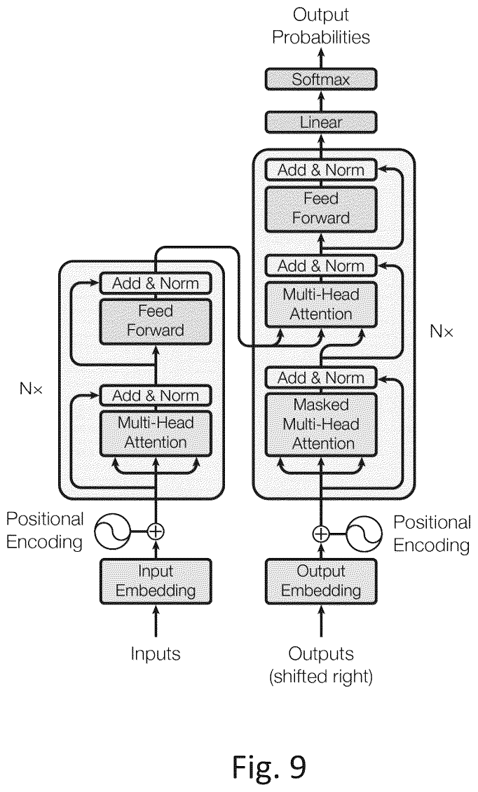

The processing by the neural layers (transformer layers) 810 is based on the concept of self-attention. Details of the neural layers 810 of the transformer 800 according to a particular example are shown in FIG. 9. The left-hand side of FIG. 9 shows one of a plurality of encoder neural layers and the right-hand side of FIG. 9 shows one of a plurality of decoder neural layers of the transformer 800. In principle, the transformer 800 may comprise both an encoder stack and a decoder stack or an encoder stack only. Each of the neural layers 810 of the transformer 800 comprises a multi-head self-attention layer and a (fully connected) feed forward neural network. The self-attention layer helps the encoder stack to look at other portions of an object (for example, patches of an image or words) as it encodes a specific portion of an object (for example, a patch of an image or a word of a sentence). The outputs of the self-attention layer are fed to a feed-forward neural network. The decoder stack also has both those components and between them an additional “encoder-decoder”) attention layer that helps the decoder stack to focus on relevant parts of the input data. Each portion of an object to be processed (for example, a patch of an image or a word of a sentence) in each position flows through its own path in the encoder. There are dependencies between these paths in the self-attention layer. The feed-forward layer does not have those dependencies, however, and, therefore, the various paths can be executed in parallel while flowing through the feed-forward layer.

In the multi-head self-attention layer of the encoder stack Query Q, Key K and Value V tensors and the self-attention

$$Attention ( Q , K , V ) = softmax ( \frac{{QK}^{T}}{\sqrt{{d}_{k}}} ) V$$

are computed wherein dₖ denotes the dimension of the key tensor and the softmax function provides the final attention weights as probability distribution.

Each sub-layer (self-attention attention layer and feed forward neural network) in each encoder and decoder layer has a residual connection around it and is followed by a normalization layer (see FIG. 9).

The output of the top encoder layer is transformed into a set of attention vectors K and V. These are to be used by each decoder layer in its “encoder-decoder attention” layer. The “encoder-decoder attention” layers operate similar to the multi-head self-attention layers of the encoder stack except that they create Query matrices from the respective layers below and take the Key and Value matrices from the output of the encoder stack (see FIG. 9).

The decoder stack outputs a vector of floats that is converted into portions of an object (for example, patches of an image or words of a sentence) by a final Linear layer (fully connected neural network) that outputs logits and is followed by a Softmax Layer that produces a highest probability output.

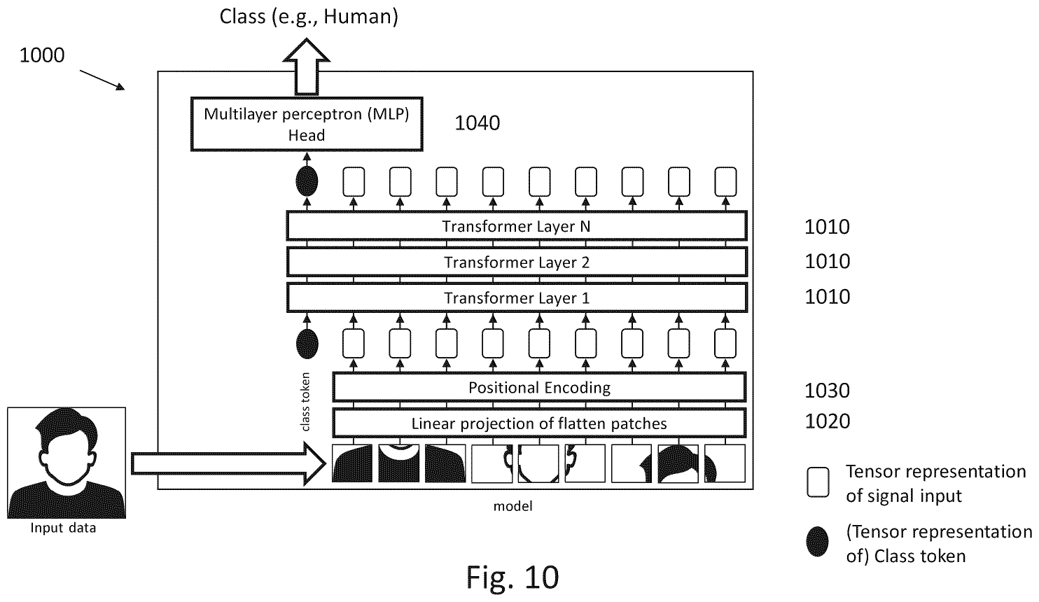

FIG. 10 shows a transformer 1000 similar to the transformer 800 shown in FIG. 8. The transformer 1000 also comprises neural layers 1010, a linear projection layer 1020 for projecting input data into tensor (latent) space and a positional encoding layer 1030. However, additionally a class token is used that does not belong to the input data described above but is a vector learned during gradient descent. It is noted that the terminology in the art is not consistently fixed. For example, sometimes the extra data actually processed by the transformer 1000 is denoted by the term “token” sometimes it is denoted by the term “embedding”. The class token/embedding is pathed through the neural layers 1010 for classification processes. The class token/embedding is learned in a training phase and kept fixed in neural network inference, i.e., the class token does not represent variable input. A Multilayer Perceptron (MLP) head 1040 outputs the class (for example, human) of the processed object (for example, image). In other word, the transformer 1000 operates as a classifier. The architecture shown in FIG. 9 may at least partly be comprised by the transformer 1000.

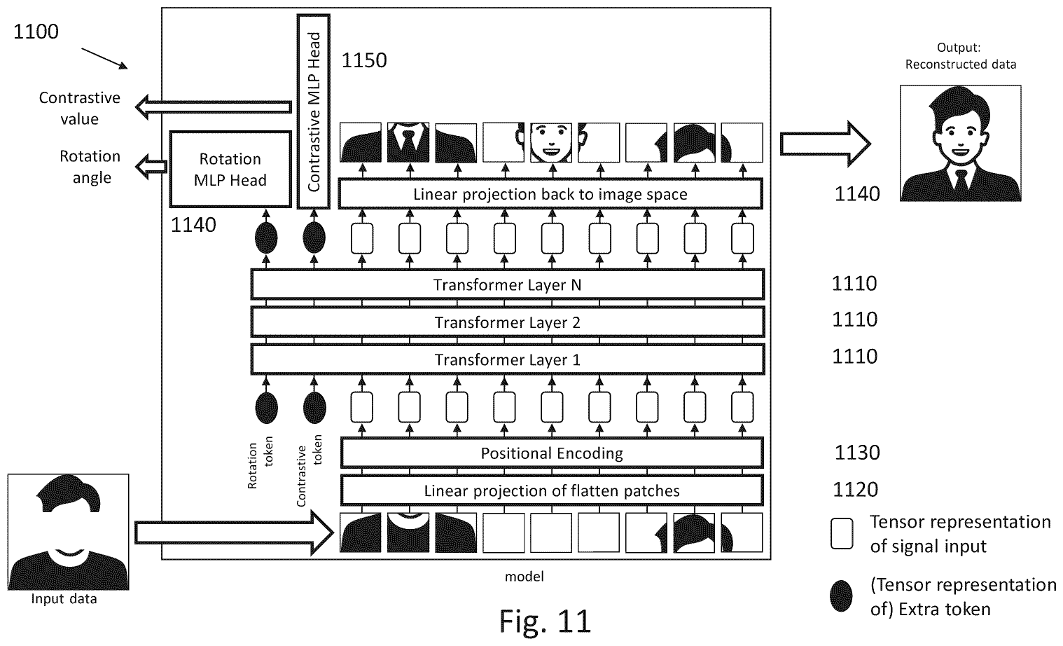

FIG. 11 shows another example of a transformer 1100 of the art similar to the transformer 800 shown in FIG. 8. The transformer 1100 also comprises neural layers 1110, a linear projection layer 1120 for projecting input data into tensor (latent) space and a positional encoding layer 1130. Additionally, two extra tokens are used, one representing information related to rotation of an image to be processed, the other one representing information related to contrastive learning. The rotation and contrastive tokens represent extra input data. The rotation and contrastive tokens are learned in a training phase and kept fixed in neural network inference. Again, the extra data actually processed by the transformer 1100 in tensor space may be named “embeddings”. The extra tokens/embeddings are pathed through the neural layers 1110 to a rotation MLP head 1140 and a contrastive MLP head 1150, respectively, that output respective values used for identification/discrimination of particular features of (a patch of) an image. The architecture shown in FIG. 9 may at least partly be comprised by the transformer 1100.

More details of the exemplary transformers of the art described above can be found in:
Attention Is All You Need. Ashish Vaswani, Noam Shazeer, Niki Parmar, Jakob Uszkoreit, Llion Jones, Aidan N. Gomez, Lukasz Kaiser, Illia Polosukhin, https://arxiv.org/abs/1706.03762
BERT: Pre-training of Deep Bidirectional Transformers for Language Understanding, Jacob Devlin Ming-Wei Chang Kenton Lee Kristina Toutanova, Google AI Language, https://arxiv.org/pdf/1810.04805.pdf/
AN IMAGE IS WORTH 16×16 WORDS: TRANSFORMERS FOR IMAGE RECOGNITION AT SCALE, Alexey Dosovitskiy, Lucas Beyer, Alexander Kolesnikov et al, Google Research, Brain Team, https://arxiv.org/pdf/2010.11929.pdf/
Training data-efficient image transformers & distillation through attention, Hugo Touvron, Matthieu Cord, Matthijs Douze et al, Facebook AI, https://arxiv.org/pdf/2012.12877
Going deeper with Image Transformers. Hugo Touvron, Matthieu Cord, Alexandre Sablayrolles et al. Facebook AI, https://arxiv.org/pdf/2103.17239
SiT: Self-supervised vision Transformer, Sara Atito, Muhammad Awais, Josef Kittler, IEEE, https://arxiv.org/abs/2104.03602

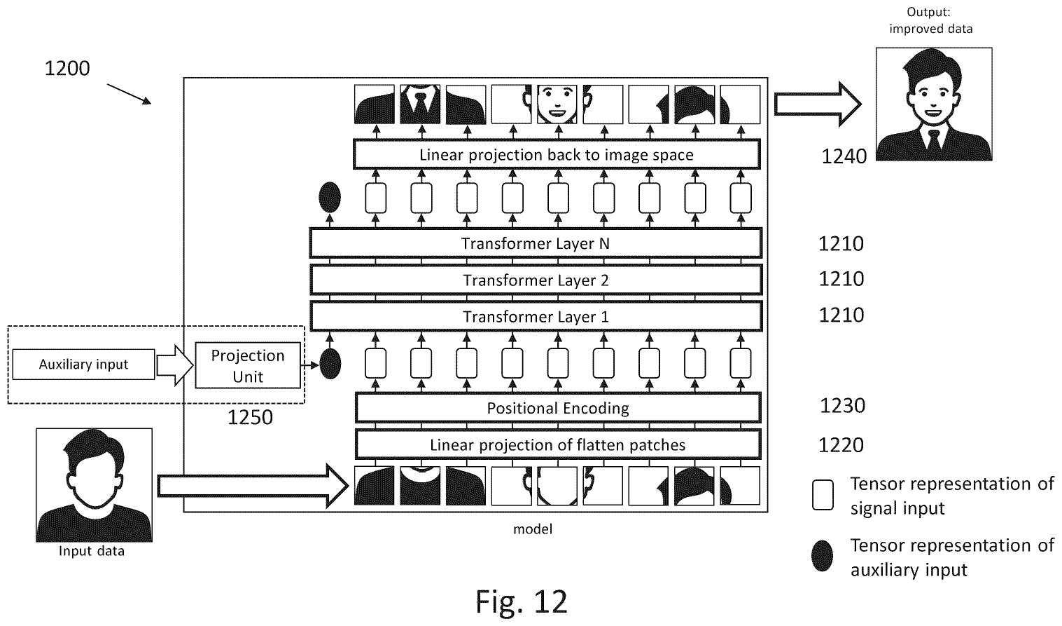

The above-described transformers of the art do not make use of information on how (much) an object is to be processed or what particular kind of object is to be processed. The present disclosure provides an improved usage of a transformer as compared to the art. Operation of a transformer 1200 according to an embodiment provided herein is illustrated in FIG. 12. The architecture of the transformer 1200 may be similar to the one of any of the transformers described above. The transformer 1200 comprises a number of neural layers (transformer layers) 1210, a linear projection layer 1220 for obtaining input data tensors (a tensor representation of signal input) and a positional encoding layer 1230 for encoding positional relationships between portions of the object. A linear projection layer 1240 converts the result output by the final one of the neural layers 1210 into object space. It is noted that in other embodiments, for example, directed to a mere classification task, no linear projection layer 1240 is needed bit some MLP head (for example, for providing a class output) is provided as described with reference to FIGS. 10 and 11. It goes without saying that both such a (for example, classification) head and a linear projection layer 1240 may be provided. In the embodiment shown in FIG. 12 image processing is addressed. It is to be understood that processing of other objects, for example, sentences or audio signals, are also covered by this embodiment as well as the other embodiments that are described in the following.

Contrary to the art, an auxiliary input is used for processing an object by a transformer based neural network wherein the auxiliary input depends on information on processing the object and/or information about properties of the object (for example, image, text or audio signal) that is to be processed. This auxiliary input is variable in the sense that it is not fixed as a result of a training phase of the transformer based neural network but relates to the current object itself. For example, the auxiliary input can be obtained from a bitstream that is generated for the object and includes information about how to process the object, for example, how to decode the object.

The at least one auxiliary data tensor can be processed by the same mathematical operations in the neural layer as the mathematical operations applied to the input data tensors. Particularly, the same weights may be applied to the at least one auxiliary data tensor and the input data tensors in the same neural layer. The auxiliary data tensor influences the processing of the input data tensors through the self-attention layer(s) comprised in the neural layers 1210 of the transformer 1200.

In the context of image processing, examples for an auxiliary input comprise one or more of the following:
content, class/type of content—for example, a screen content or content like communication, nature, sport, etc.;
a quality indicating parameter—for example, a codecs quality parameter or beta;
channel-wise distortion metrics in signal space—for example, for Y, U, V or R, G, B, MSE, MSSIM or PSNR;
channel-wise distortion metrics in a latent space—for example, higher or lower distortion in a (DCT) frequency domain;
brightness, contrast, blurring, warmness, sharpness, saturation, color Histogram, cade;
shadowing, luminance, vignette control, painting style;
discontinuously variable filter strength, continuously variable filter strength (between some minimum and some maximum)—for example, as used in user applications with scrollbar control as, for instance, Photoshop, Instagram, etc., for example, softening, idealization, aging, etc.;
indication of intra prediction or inter prediction; and
conversion rate for object replacement applications—for example, as in deep fake application.

In the context of language/text processing, examples for an auxiliary input comprise one or more of the following:
content, type of content—for example, poetry, novel, horror, detective, text, speech, etc.;
temperature (a hyper-parameter of neural networks used to control the randomness of predictions by scaling the logits output by a final linear layer before applying softmax);
language—for example, English, a dialect, etc.; and
affection—for example, joke, aggression, drama, etc.

In the context of audio signal processing, examples for an auxiliary input comprise one or more of the following:
content, type of content—for example, classic, rock, pop, speech, music, etc.;
a quality indicating parameter—for example, a codecs quality parameter;
channel-wise distortion metrics in signal space;
channel-wise distortion metrics in any latent space—for example, in the frequency domain;
equalizer settings;
volume; and
conversion rate—for example, spectrum changing, voice changing, etc.

The auxiliary input is converted into one or more auxiliary data tensors (a tensor representation of the auxiliary input) by a projection unit 1250. The projection unit 1250 may be configured for linearly or non-linearly converting the at least one auxiliary input into the at least one auxiliary data tensor. The projection unit 1250 may comprise a neural network for performing the conversion.

For example, when the auxiliary input is a scalar, like a quality parameter QP, an auxiliary data tensor by be obtained by A*QP+B, wherein A and B are tensors consisting of neural network parameters. A and B have dimensions equal to the transformer model and are pre-trained like the other parameter of the transformer model. In other examples, the auxiliary data tensor may depend non-linearly on QP.

The input data tensors are processed by the transformer 1200 using the information provided by the auxiliary input. The auxiliary data tensor(s) may be added to or concatenated with the input data tensors for processing. Weights and activation functions involved in the processing of the input data tensors may depend on the one or more auxiliary data tensors. Due to the employment of the information provided by the auxiliary input the result output by the transformer 1200 can be improved, for example, in terms of some quality metrics applied to the output (for example, a sharper image, an image richer in contrast, a more accurate translation of a word, a less noisy audio signal, etc.).

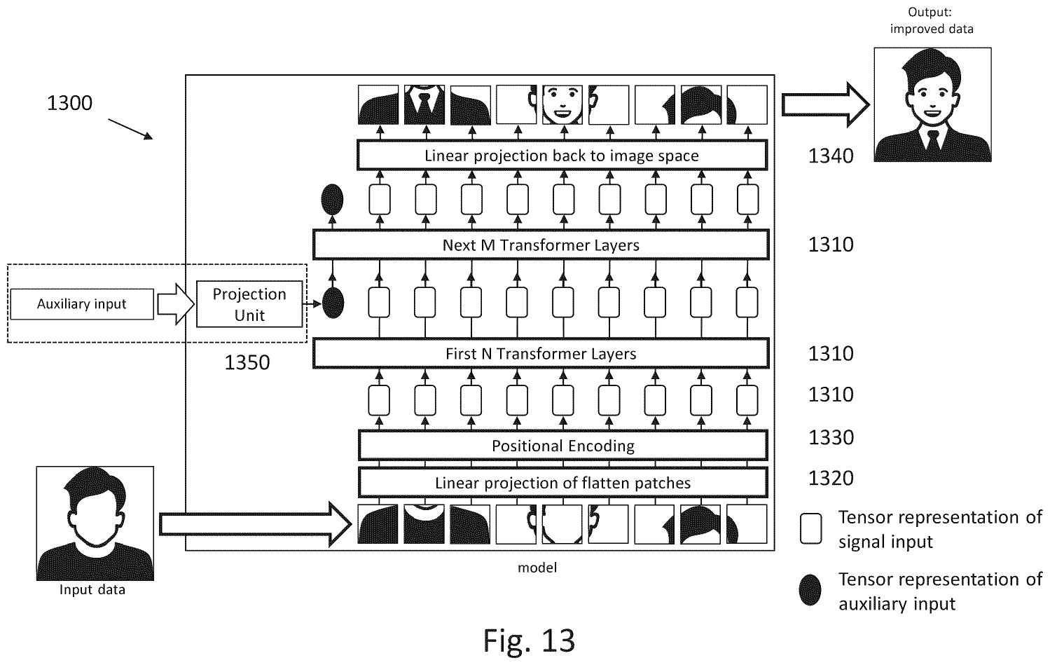

Operation of a transformer 1300 according to another embodiment provided herein is illustrated in FIG. 13. The architecture of the transformer 1300 may be similar to the transformer 1200 shown in FIG. 12. The transformer 1300 comprises a number of neural layers (transformer layers) 1310, a linear projection layer 1320 for obtaining input data tensors (a tensor representation of signal input) and a positional encoding layer 1330 for encoding positional relationships between portions of the object. A linear projection layer 1340 converts the result output by the final one of the neural layers 1310 into object space.

One or more of the above-mentioned examples for an auxiliary input may be used. The auxiliary input is converted into one or more auxiliary data tensors (a tensor representation of the auxiliary input) by a projection unit 1350. The projection unit 1350 may be configured for linearly or non-linearly converting the at least one auxiliary input into the at least one auxiliary data tensor. The projection unit 1350 may comprise a neural network for performing the conversion. The input data tensors are processed by the transformer 1300 using the information provided by the auxiliary input. However, different from the embodiment described with reference to FIG. 12, in the embodiment illustrated in FIG. 13 the one or more auxiliary data tensors are input at some higher-level layer of the neural layers 1310 rather than an initial neural layer. Influence of the auxiliary input on the output of the transformer 1300 can, thereby, flexibly controlled.

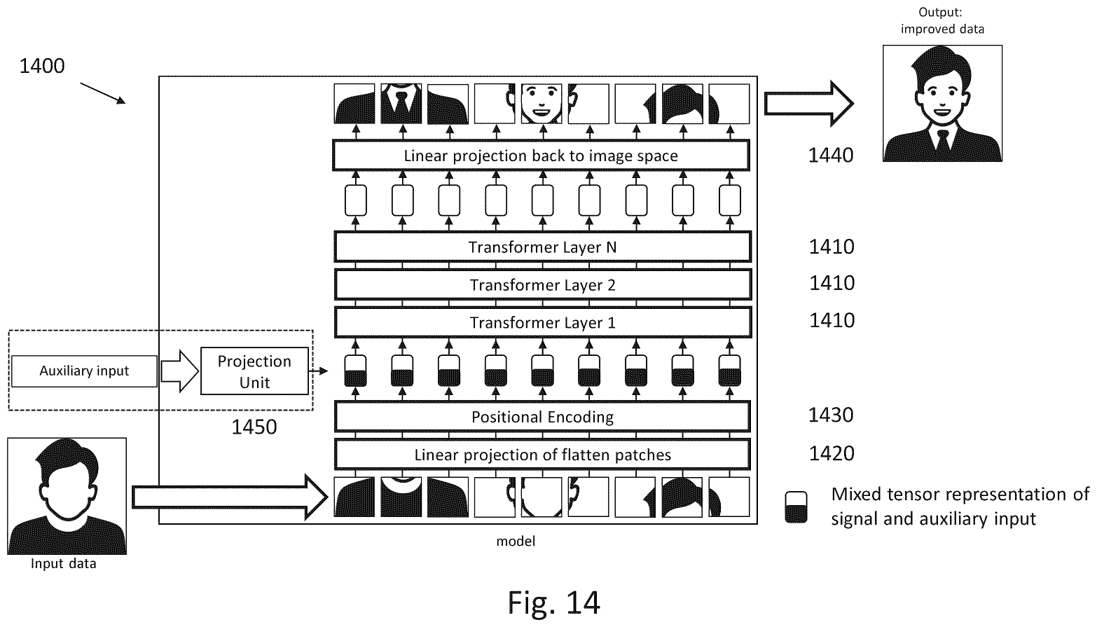

Operation of a transformer 1400 according to another embodiment provided herein is illustrated in FIG. 14. The architecture of the transformer 1400 may be similar to the transformer 1200 shown in FIG. 12. The transformer 1400 comprises a number of neural layers (transformer layers) 1310, a linear projection layer 1420 for obtaining input data tensors (a tensor representation of signal input) and a positional encoding layer 1430 for encoding positional relationships between portions of the object. A linear projection layer 1440 converts the result output by the final one of the neural layers 1410 into object space.

One or more of the above-mentioned examples for an auxiliary input may be used. However, different from the embodiments described with reference to FIGS. 12 and 14, in this embodiment the auxiliary data tensor(s) is (are) not input separately from the input data tensors but a mixture of one or more auxiliary data tensors and input data tensors is input into the transformer 1400. The one or more auxiliary data tensors are obtained from one or more auxiliary inputs by a projection unit 1450. The projection unit 1450 may be configured for linearly or non-linearly converting the at least one auxiliary input into the at least one auxiliary data tensor. The projection unit 1450 may comprise a neural network for performing the conversion. The mixture of the tensors might be obtained by concatenation and the mixed tensors are input into a neural layer 1410 of the transformer 1400. The processing of each or some of the input data tensors can, thus, individually be influenced by the at least one auxiliary data tensor. Moreover, it might be easier to process the mixed tensors rather than input data tensors and one or more auxiliary data tensors that are separately input into one or more neural layers. It is noted that the one or more auxiliary data tensors may, additionally or alternatively. be mixed with some outputs of one of the neural layers 1410.

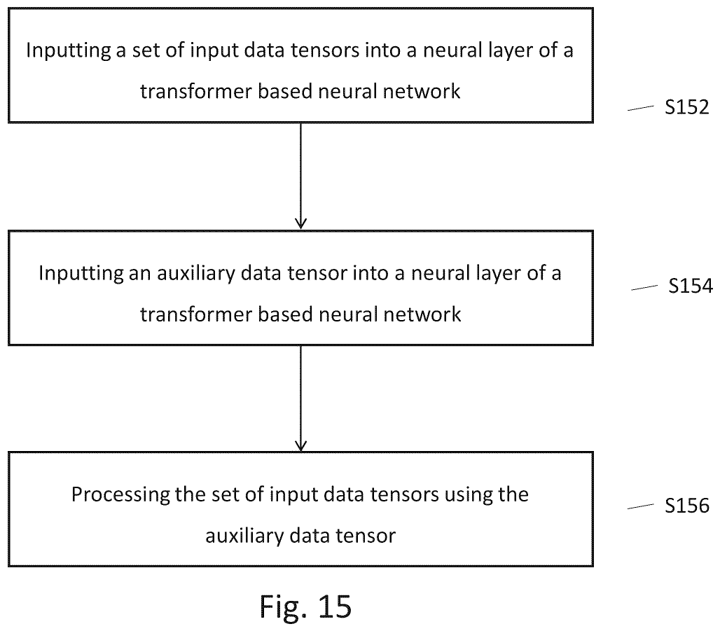

A method of processing a current object (for example, an image or a sentence or an audio signal) according to an embodiment is shown in the flow chart of FIG. 15. The method can be implemented in one of the transformers 1200, 1300 and 1400 shown in FIGS. 12. 13 and 14, respectively. The method comprises inputting S152 a set of input data tensors representing the current object into a neural layer of a transformer based neural network. Further, the method comprises inputting S154 at least one auxiliary data tensor into a neural layer of the transformer based neural network (either the same neural layer into which the at least one auxiliary data tensor is input or a different neural layer), wherein the at least one auxiliary data tensor is different from each of the input data tensors of the set of input data tensors and represents at least one auxiliary input. Further, the method comprises processing S156 the set of input data tensors by the transformer based neural network using the at least one auxiliary data tensor in order to obtain a set of output data tensors. The at least one auxiliary data tensor that is input into the neural layer depends on information about processing the current object (which is provided by the auxiliary input).

One or more of the above-mentioned examples for an auxiliary input may be used. The at least one auxiliary data tensor may be input into the neural layer separately from the input data tensors (cf. embodiments illustrated in FIGS. 12 and 13) or mixed with at least some of them (cf. embodiment illustrated in FIG. 14). The object according to the method illustrated in FIG. 15 may be processed during neural network inference or during neural network training.

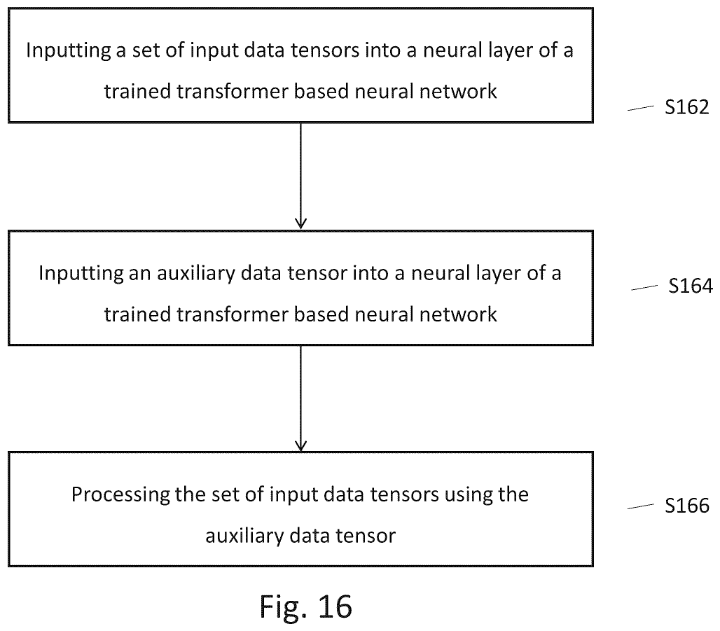

A method of processing a current object (for example, an image or a sentence or an audio signal) by neural network inference according to an embodiment is shown in the flow chart of FIG. 16. The method can be implemented in one of the transformers 1200, 1300 and 1400 shown in FIGS. 12, 13 and 14, respectively. The method illustrated in FIG. 16 comprises inputting S162 a set of input data tensors representing the current object into a neural layer of a trained transformer based neural network. Further, this method comprises inputting S164 at least one auxiliary data tensor into a neural layer of the trained transformer based neural network, wherein the at least one auxiliary data tensor is different from each of the input data tensors of the set of input data tensors and represents at least one auxiliary input. Furthermore, this method comprises processing S166 the set of input data tensors by the trained transformer based neural network using the at least one auxiliary data tensor in order to obtain a set of output data tensors. The at least one auxiliary data tensor that is input into the neural layer depends on at least one of information about properties of the current object (which is provided by the auxiliary input) and information about processing the current object (which is provided by the auxiliary input).

One or more of the above-mentioned examples for an auxiliary input may be used. The at least one auxiliary data tensor may be input into the neural layer separately from the input data tensors (cf. embodiments illustrated in FIGS. 12 and 13) or mixed with at least some of them (cf. embodiment illustrated in FIG. 14).

At least one of the methods illustrated in FIGS. 15 and 16 may be comprised by a method of encoding an image or a method of decoding an encoded image. At least one of the methods illustrated in FIGS. 15 and 16 may be comprised by a method of image enhancement or a method of auto-encoding an image.

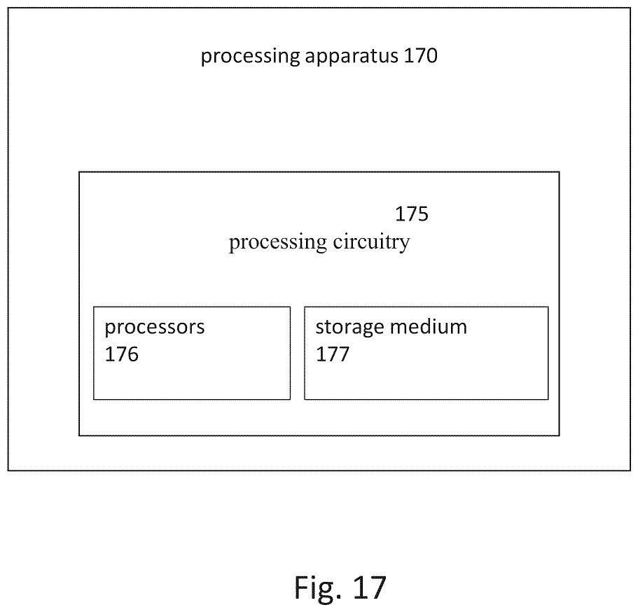

The methods illustrated in FIGS. 15 and 16 may be implemented in a processing apparatus comprising a processing circuitry that is configured for performing the steps of these methods. Particularly, the methods illustrated in FIGS. 15 and 16 may be implemented in a processing apparatus 170 as illustrated in FIG. 17. The processing apparatus 170 comprises a processing circuitry 175. One or more processors 176 are comprised by the processing circuitry 175. The one or more processors 176 are coupled in data communication linkage with a non-transitory computer-readable storage medium 177. The non-transitory computer-readable storage medium 177 stores programming for execution by the one or more processors 176, wherein the programming, when executed by the one or more processors 176, configures the processing apparatus 170 to carry out the method according to the embodiments described above with reference to FIG. 15 and FIG. 16, respectively.

The processing apparatus 170 may be comprised by an encoding or decoding device. For example, the processing apparatus 170 may be comprised by an encoding device for encoding an image (for example, a still image or a frame of a video sequence) or a decoding device for decoding an encoded image (for example, a still image or a frame of a video sequence). The processing apparatus 170 may be comprised by an auto-encoding device configured for coding an image (for example, a still image or a frame of a video sequence).

The methods illustrated in FIGS. 15 and 16 may also be implemented in the devices and systems described in the following. The processing apparatus 170 may also be comprised in the devices and systems described in the following.

### Some Exemplary Implementations in Hardware and Software

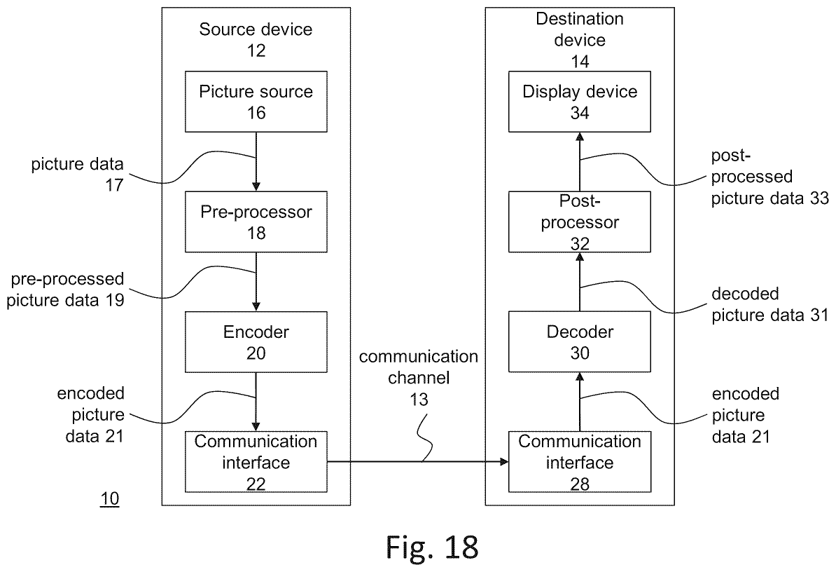

FIG. 18 is a schematic block diagram illustrating an example coding system, e.g. a video, image, audio, and/or other coding system (or short coding system) that may utilize techniques of this present application, particularly, a transformer based neural network, for example, a transformer based neural network as illustrated in any of the FIGS. 12 to 14. Video encoder 20 (or short encoder 20) and video decoder 30 (or short decoder 30) of video coding system 10 represent examples of devices that may be configured to perform techniques in accordance with various examples described in the present application. For example, the video coding and decoding may employ a transformer based neural network, for example, a transformer based neural network as illustrated in any of the FIGS. 12 to 14, and optionally a neural network such as the ones shown in FIGS. 1 to 6 which may be distributed and which may apply the above-mentioned bitstream parsing and/or bitstream generation to convey feature maps between the distributed computation nodes (two or more).

As shown in FIG. 18, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (for example, a transformer based neural network as illustrated in any of the FIGS. 12 to 14 and optionally a neural network such as shown in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 18 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31 (e.g., employing a transformer based neural network as illustrated in any of the FIGS. 12 to 14 and optionally a neural network based on one or more of the ones shown in FIGS. 1 to 7).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g., comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 18 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 18 may vary depending on the actual device and application.

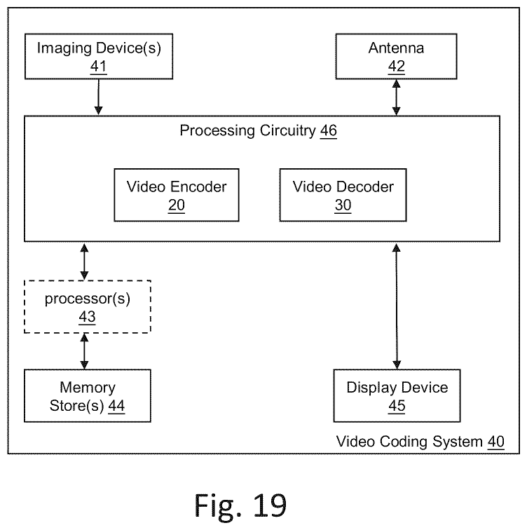

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including a transformer based neural network as illustrated in any of the FIGS. 12 to 14 and optionally the neural network such as the one shown in any of FIGS. 1 to 6 or its parts. The decoder 30 may be implemented via processing circuitry 46 to embody the various modules as discussed with respect to FIGS. 1 to 7 and/or any other decoder system or subsystem described herein. The processing circuitry 46 may be configured to perform various operations including the methods provided herein. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 19.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 18 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

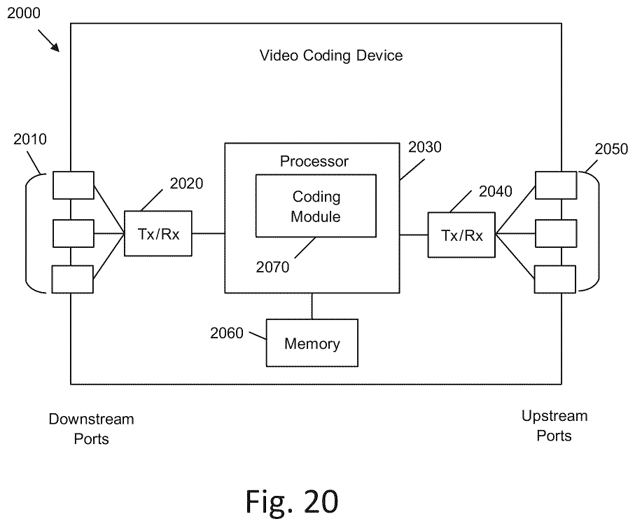

FIG. 20 is a schematic diagram of a video coding device 2000 according to an embodiment of the disclosure. The video coding device 2000 is suitable for implementing the disclosed embodiments as described herein. In an embodiment, the video coding device 2000 may be a decoder such as video decoder 30 of FIG. 18 or an encoder such as video encoder 20 of FIG. 18.

The video coding device 2000 comprises ingress ports 2010 (or input ports 2010) and receiver units (Rx) 2020 for receiving data; a processor, logic unit, or central processing unit (CPU) 2030 to process the data; transmitter units (Tx) 2040 and egress ports 2050 (or output ports 2050) for transmitting the data; and a memory 2060 for storing the data. The video coding device 2000 may also comprise optical-to-electrical (OE) components and electrical-to-optical (EO) components coupled to the ingress ports 2010, the receiver units 2020, the transmitter units 2040, and the egress ports 2050 for egress or ingress of optical or electrical signals.

The processor 2030 is implemented by hardware and software. The processor 2030 may be implemented as one or more CPU chips, cores (e.g., as a multi-core processor), FPGAs, ASICs, and DSPs. The processor 2030 is in communication with the ingress ports 2010. receiver units 2020, transmitter units 2040, egress ports 2050, and memory 2060. The processor 2030 comprises a coding module 2070. The coding module 2070 implements the disclosed embodiments described above. For instance, the coding module 2070 implements, processes, prepares, or provides the various coding operations. The inclusion of the coding module 2070 therefore provides a substantial improvement to the functionality of the video coding device 2000 and effects a transformation of the video coding device 2000 to a different state. Alternatively, the coding module 2070 is implemented as instructions stored in the memory 2060 and executed by the processor 2030.

The memory 2060 may comprise one or more disks, tape drives, and solid-state drives and may be used as an over-flow data storage device, to store programs when such programs are selected for execution, and to store instructions and data that are read during program execution. The memory 2060 may be, for example, volatile and/or non-volatile and may be a read-only memory (ROM), random access memory (RAM), ternary content-addressable memory (TCAM), and/or static random-access memory (SRAM).

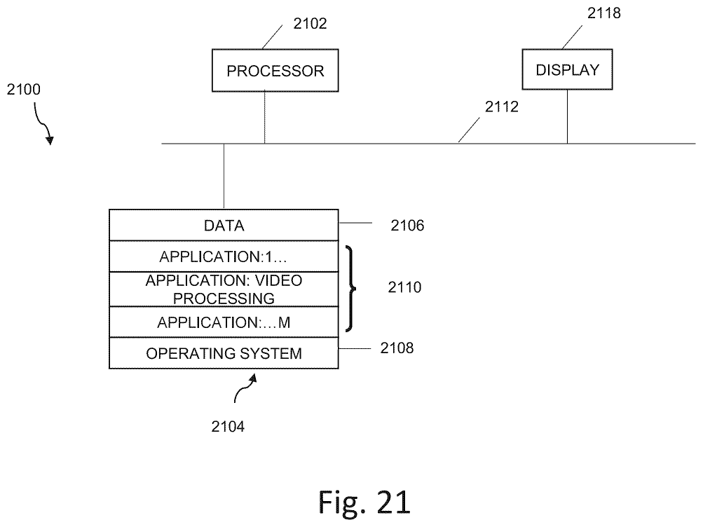

FIG. 21 is a simplified block diagram of an apparatus 2100 that may be used as either or both of the source device 12 and the destination device 14 from FIG. 18 according to an exemplary embodiment.

A processor 2102 in the apparatus 2100 can be a central processing unit. Alternatively, the processor 2102 can be any other type of device, or multiple devices, capable of manipulating or processing information now-existing or hereafter developed. Although the disclosed implementations can be practiced with a single processor as shown, e.g., the processor 2102, advantages in speed and efficiency can be achieved using more than one processor.

A memory 2104 in the apparatus 2100 can be a read only memory (ROM) device or a random access memory (RAM) device in an implementation. Any other suitable type of storage device can be used as the memory 2104. The memory 2104 can include code and data 2106 that is accessed by the processor 2102 using a bus 2112. The memory 2104 can further include an operating system 2108 and application programs 2110, the application programs 2110 including at least one program that permits the processor 2102 to perform the methods described here. For example, the application programs 2110 can include applications 1 through N, which further include a video coding application that performs the methods described here.

The apparatus 2100 can also include one or more output devices, such as a display 2118. The display 2118 may be, in one example, a touch sensitive display that combines a display with a touch sensitive element that is operable to sense touch inputs. The display 2118 can be coupled to the processor 2102 via the bus 2112.

Although depicted here as a single bus, the bus 2112 of the apparatus 2100 can be composed of multiple buses. Further, a secondary storage can be directly coupled to the other components of the apparatus 2100 or can be accessed via a network and can comprise a single integrated unit such as a memory card or multiple units such as multiple memory cards. The apparatus 2100 can thus be implemented in a wide variety of configurations.

Furthermore, the processing apparatus 170 shown in FIG. 17 may comprise the source device 12 or destination device 14 shown in FIG. 18, the video coding system 40 shown in FIG. 19, the video coding device 2000 shown in FIG. 20 or the apparatus 2100 shown in FIG. 21.

1. A method of processing a current object, the method comprising:
inputting a set of input data tensors representing the current object into a first neural layer of a transformer based neural network;
inputting, based on information about processing the current object, at least one auxiliary data tensor into the first neural layer or a second neural layer of the transformer based neural network, wherein the at least one auxiliary data tensor is different from each of the input data tensors of the set of input data tensors and represents at least one auxiliary input; and
processing the set of input data tensors by the transformer based neural network using the at least one auxiliary data tensor in order to obtain a set of output data tensors.

2. The method of claim 1, wherein the current object is processed during neural network inference.

3. The method of claim 1, wherein the current object is processed during neural network training.

4. The method of claim 1, wherein the set of input data tensors is input separately from the at least one auxiliary data tensor.

5. The method of claim 1, wherein the set of input data tensors is input into the first neural layer of the transformer based neural network and the at least one auxiliary data tensor is input into the second neural layer of the transformer based neural network that is different from the first neural layer.

6. The method claim 1, wherein inputting the set of input data tensors and the at least one auxiliary data tensor comprises:
generating a set of different mixed input tensors wherein each mixed input tensor of the set of different mixed input tensors comprises at least one of the at least one auxiliary data tensor and one input data tensor of the set of input data tensors; and
inputting the set of mixed input tensors into the first neural layer of the transformer based neural network.

7. The method of claim 1, further comprising generating the at least one auxiliary data tensor by one of:
linearly converting the at least one auxiliary input into the at least one auxiliary data tensor;
non-linearly converting the at least one auxiliary input into the at least one auxiliary data tensor; and
converting the at least one auxiliary input into the at least one auxiliary data tensor by means of another neural network.

8. The method of claim 1, wherein the information about processing the current object is information about processing the current object over a continuous parameter range.

9. The method of claim 8, further comprising obtaining the information about processing the current object from a bitstream generated for the object.

10. The method of claim 1, wherein the current object comprises one of an image or a part of an image.

11. (canceled)

12. The method of claim 10, wherein the at least one auxiliary input is selected from a group comprising:
a quality indicating parameter;
channel-wise distortion metrics in signal space;
channel-wise distortion metrics in a latent space;
brightness, contrast, blurring, warmness, sharpness, saturation, color Histogram, cade;
shadowing, luminance, vignette control, painting style;
discontinuously variable filter strength, continuously variable filter strength;
indication of intra prediction or inter prediction; and
conversion rate for object replacement applications.

13. A method of encoding an image, the method comprising the method of claim 10.

14. A method of decoding an encoded image, the method comprising the method of claim 10.

15. The method of claim 13, wherein the transformer based neural network is comprised in an inloop filter.

16. (canceled)

17. The method of claim 1, wherein the current object comprises one or more sentences, and wherein the at least one auxiliary input is selected from a group comprising temperature, language, and affection.

18. (canceled)

19. The method of claim 1, wherein the current object comprises an audio signal, and wherein the at least one auxiliary input is selected from a group comprising:
a quality indicating parameter;
channel-wise distortion metrics in signal space;
channel-wise distortion metrics in any latent space;
equalizer settings;
volume; and
conversion rate.

20-22. (canceled)

23. A method of processing a current object by neural network inference, comprising:
inputting a set of input data tensors representing the current object into a first neural layer of a trained transformer based neural network;
inputting, based on at least one of information about properties of the current object and information about processing the current object, at least one auxiliary data tensor into the first neural layer or a second neural layer of the trained transformer based neural network, wherein the at least one auxiliary data tensor is different from each of the input data tensors of the set of input data tensors and represents at least one auxiliary input; and
processing the set of input data tensors by the trained transformer based neural network using the at least one auxiliary data tensor in order to obtain a set of output data tensors.

24. The method of claim 23, wherein the set of input data tensors is input separately from the at least one auxiliary data tensor.

25. The method of claim 23, wherein the set of input data tensors is input into the first neural layer of the trained transformer based neural network and the at least one auxiliary data tensor is input into the second neural layer of the trained transformer based neural network that is different from the first neural layer.

26. The method of claim 23, wherein inputting the set of input data tensors and the at least one auxiliary data tensor comprises:
generating a set of different mixed input tensors wherein each mixed input tensor of the set of different mixed input tensors comprises at least one of the at least one auxiliary data tensor and one input data tensor of the set of input data tensors; and
inputting the set of mixed input tensors into the first neural layer of the trained transformer based neural network.

27-45. (canceled)

46. A non-transitory computer readable medium comprising a code which when executed on one or more processors performs a method of processing a current object by neural network inference, the method comprising:
inputting a set of input data tensors representing the current object into a first neural layer of a transformer based neural network;
inputting, based on information about processing the current object, at least one auxiliary data tensor into the first neural layer or a second neural layer of the transformer based neural network, wherein the at least one auxiliary data tensor is different from each of the input data tensors of the set of input data tensors and represents at least one auxiliary input; and
processing the set of input data tensors by the transformer based neural network using the at least one auxiliary data tensor in order to obtain a set of output data tensors.

47. A processing apparatus comprising:
one or more processors; and
a non-transitory computer-readable storage medium coupled to the one or more processors and storing programming for execution by the one or more processors, wherein the programming, when executed by the one or more processors, configures the processing apparatus to carry out a method of processing a current object by neural network inference, the method comprising:
inputing a set of input data tensors representing the current object into a first neural layer of a transformer based neural network;
inputing, based on information about processing the current object, at least one auxiliary data tensor into the first neural layer or a second neural layer of the transformer based neural network, wherein the at least one auxiliary data tensor is different from each of the input data tensors of the set of input data tensors and represents at least one auxiliary input; and
processing the set of input data tensors by the transformer based neural network using the at least one auxiliary data tensor in order to obtain a set of output data tensors.

48-50. (canceled)
